(19) United States
(12) Patent Application Publication
(10) Pub. No.: US 2021/0016710 A1
(43) Pub. Date: Jan. 21, 2021

(54) APPARATUS FOR RECORDING DRIVING IMAGE OF VEHICLE AND METHOD THEREOF

(71) Applicants: HYUNDAI MOTOR COMPANY, SEOUL (KR); KIA MOTORS CORPORATION, SEOUL (KR)

(72) Inventors: Su Woong Eo, Anyang-si (KR); Gun Ho Lee, Incheon (KR)

(21) Appl. No.: 16/666,534

(22) Filed: Oct. 29, 2019

(30) Foreign Application Priority Data
Jul. 17, 2019 (KR) 10-2019-0086487

(51) Int. Cl. B60R 1/00

(52) U.S. Cl. CPC B60R 1/002; B60R 2300/302; B60R 2300/70

(57) ABSTRACT

Disclosed are an apparatus for recording a driving image of a vehicle and a method thereof. The apparatus includes a photographing device that photographs the driving image of the vehicle, an impact sensor that senses an impact amount applied to the vehicle, and a controller that determines whether to record a driving image corresponding to the impact amount sensed by the impact sensor based on accident exception point information.

### CROSS-REFERENCE TO RELATED APPLICATION

This application claims the benefit of priority to Korean Patent Application No. 10-2019-0086487, filed in the Korean Intellectual Property Office on Jul. 17, 2019, the entire contents of which are incorporated herein by reference.

### TECHNICAL FIELD

The present disclosure relates to a technology for determining whether to record a driving image in conjunction with an audio video navigation (AVN) system mounted on a vehicle.

### BACKGROUND

In general, an apparatus for recording a driving image of a vehicle includes a camera that photographs the driving image of the vehicle, an image processor that converts the driving image photographed by the camera into a digital signal to generate digital image information, constant image storage that continuously stores the digital image information generated by the image processor in real time, an impact sensor that senses external impact to measure an impact amount, a controller that compares the impact amount measured by the impact sensor with a reference value to determine whether the impact amount is valid or invalid, event image storage that stores the digital image information corresponding to the valid impact, a display that displays the driving image photographed by the camera, an audio device that provides a voice corresponding to the driving image photographed by the camera, and an input device that inputs a control command to the controller.

In this case, the constant image storage continuously stores the digital image information corresponding to the driving image photographed by the camera, and when the storage space is insufficient thereafter, stores the digital image information newly photographed by the camera while sequentially deleting the oldest stored digital image information.

The impact sensor may be implemented as an acceleration sensor or a gyroscope sensor, but is not necessarily limited thereto.

The controller determines that a fender bender has occurred when the impact amount received from the impact sensor exceeds the reference value and stores, in the event image storage, the digital image information for about 15 seconds immediately before and about 15 seconds immediately after based on the time when the impact amount is received.

Because the apparatus for recording a driving image of a vehicle according to the related art stores the corresponding image unconditionally in the event image storage when the impact amount received from the impact sensor exceeds the reference value, the images corresponding to the impact generated from a vehicle due to a unpaved road, a pothole, a speed bump, and the like are unnecessarily stored.

This causes a waste of resources required for recording an image, and in addition, causes a lack of storage space due to the recording of unnecessary images.

The matters described in this background section are intended to promote an understanding of the background of the disclosure and may include matters that are not already known to those of ordinary skill in in the art.

### SUMMARY

The present disclosure has been made to solve the above-mentioned problems occurring in the prior art while advantages achieved by the prior art are maintained intact.

An aspect of the present disclosure provides an apparatus for recording a driving image of a vehicle and a method thereof, which can distinguish the first impact caused by a fender bender from the second impact caused by a unpaved road, a pothole, a speed bump, and the like in conjunction with an audio video navigation (AVN) system mounted on the vehicle and prevent the recording of the image corresponding to the second impact, so that it is possible to save resources required for the recording of unnecessary images and to prevent the storage space shortage due to the recording of the unnecessary images in advance.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for recording a driving image of a vehicle includes a photographing device that photographs the driving image of the vehicle, an impact sensor that senses an impact amount applied to the vehicle, and a controller that determines whether to record a driving image corresponding to the impact amount sensed by the impact sensor based on accident exception point information.

The controller may record the driving image corresponding to the impact amount when receiving accident exception point information corresponding to a current location from an audio video navigation (AVN) system mounted on the vehicle, and not record the driving image corresponding to the impact amount when not receiving the accident exception point information.

The controller may transmit impact information to an audio video navigation (AVN) system when the impact amount sensed by the impact sensor exceeds a reference value.

The AVN system may grasp a current location when receiving the impact information and match the impact information with location information to store the impact information.

The AVN system may set the current location as an accident exception point when receiving the impact information a reference number of times or more at a same location.

The AVN system may display the accident exception point on a navigation map.

The photographing device may photograph a driving image of at least one of front, rear, left and right sides of the vehicle.

According to another aspect of the present disclosure, a method of recording a driving image of a vehicle includes photographing, by a photographing device, the driving image of the vehicle, sensing, by an impact sensor, an impact amount applied to the vehicle, and determining, by a controller, whether to record a driving image corresponding to the sensed impact amount based on accident exception point information.

The determining of whether to recording the driving image may include recording the driving image corresponding to the impact amount when receiving accident exception point information corresponding to a current location from an audio video navigation (AVN) system mounted on the vehicle, and not recording the driving image corresponding to the impact amount when not receiving the accident exception point information.

The determining of whether to recording the driving image may include transmitting impact information to the AVN system when the sensed impact amount exceeds a reference value, grasping, by the AVN system, a current location, matching, by the AVN system, the impact information with location information to store the impact information, and setting, by the AVN system, the current location as an accident exception point when the impact information is received a reference number of times or more at a same location.

The method may further include displaying, by the AVN system, the accident exception point on a navigation map.

The photographing of the driving image of the vehicle may include photographing a driving image of at least one of front, rear, left and right sides of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for recording a driving image of a vehicle according to an embodiment of the present disclosure;

FIG. 2 is a view illustrating a driving image of a vehicle photographed by a photographing device included in an apparatus for recording a driving image of a vehicle according to an embodiment of the present disclosure;

FIG. 3 is a view illustrating an accident exception point displayed on a navigation map by a controller provided in an AVN system according to an embodiment of the present disclosure;

FIG. 4 is a flowchart illustrating a method of recording a driving image of a vehicle according to an embodiment of the present disclosure; and

FIG. 5 is a block diagram illustrating a computing system that executes a method of recording a driving image of a vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

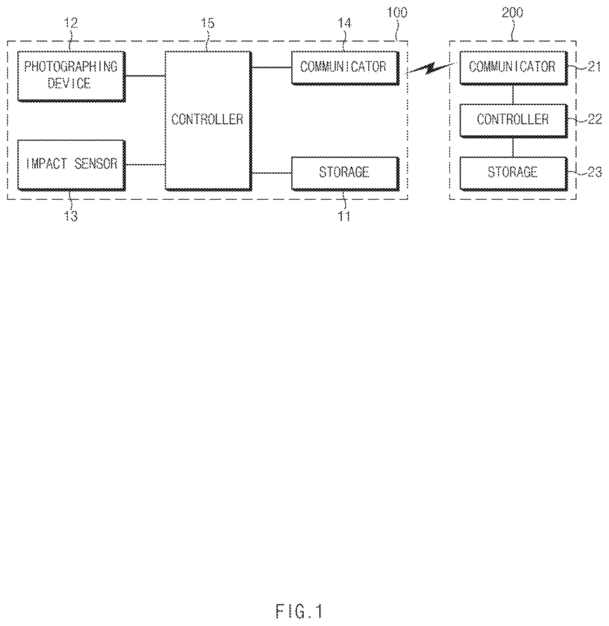

FIG. 1 is a block diagram illustrating an apparatus for recording a driving image of a vehicle according to an embodiment of the present disclosure, which may be implemented in the form of a drive video record system (DVRS).

As shown in FIG. 1, an apparatus 100 for recording a driving image of a vehicle according to an embodiment of the present disclosure, which is a module mounted on the vehicle, may include storage 11, a photographing device 12, an impact sensor 13, a communicator 14, and a controller 15. In this case, according to a scheme of implementing the apparatus 100 for recording a driving image of a vehicle according to an embodiment of the present disclosure, components may be combined with each other to be implemented as one, and some components may be omitted.

Inspecting each component, first, the storage 11 may store various logics, algorithms and programs required in the process of distinguishing the first impact caused by a fender-bender from the second impact caused by a unpaved road, a speed bump, a pothole, and the like in conjunction with an audio video navigation (AVN) system 200 mounted on the vehicle and preventing the recording of the image corresponding to the second impact.

The storage 11 may include constant image storage (not shown) for continuously storing the image photographed by the photographing device 12, and event image storage (not shown) for storing a driving image for a threshold time (e.g., about 15 seconds) immediately before and a threshold time (e.g., about 15 seconds) immediately after based on a time point at which an impact amount is transmitted when the impact amount transmitted from the impact sensor 13 exceeds a reference value.

The storage 11 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

The photographing device 12 may be implemented with, for example, a camera, and mounted on the front, rear, left side, right side of the vehicle to take a driving image.

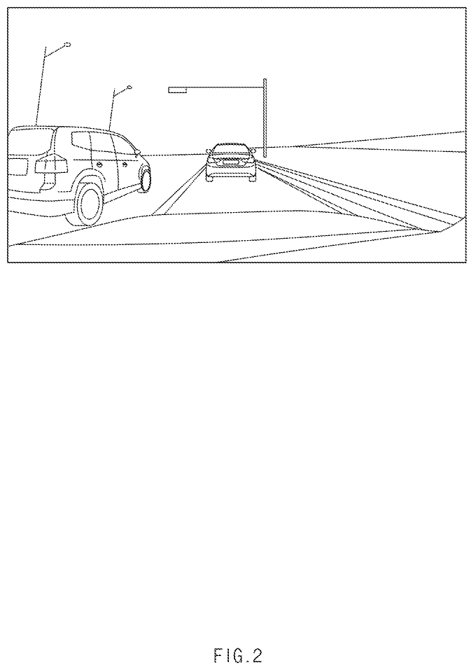

FIG. 2 is a view illustrating a driving image of a vehicle photographed by the photographing device 12 included in an apparatus for recording a driving image of a vehicle according to an embodiment of the present disclosure.

As shown in FIG. 2, when the photographing device 12 provided in an apparatus for recording a driving image of a vehicle according to an embodiment of the present disclosure is mounted on the front of the vehicle, the driving image for the front of the vehicle may be photographed.

Because a fender bender may occur in all parts of a vehicle, the photographing device 12 may be generally mounted at the front and rear of the vehicle, but may also be mounted at the right and left sides of the vehicle.

Next, the impact sensor 13 may determine whether impact is applied to the vehicle and measure an amount of impact applied to the vehicle as a kind of impact sensor.

Referring back to FIG. 1, the communicator 14 is a module for interworking with the AVN system 200 mounted on the vehicle. When the impact exceeding a reference value occurs, as a result, the communicator 141 may transmit the impact information to the AVN system 200.

In this case, the AVN system 200 may obtain a GPS location corresponding to the impact information. That is, when receiving the impact information from the communicator 14, the AVN system 200 may grasp the location of the vehicle at that time and store the impact information together with the corresponding location information, thereby allowing the user to grasp whether the impact occurs according to the location.

In particular, the AVN system 200 may set the location as an accident exception point when the impact information is received more than the reference number of times at the same location. The AVN system 200 generally includes a GPS receiver (not shown).

In addition, the communicator 14, which is a module that provides a connection interface with a communicator 21 provided in the AVN system 200, may receive the accident exception point information from the AVN system 200.

The communicator 14 may be replaced with a network connection device (not shown) accessible to a vehicle network. In this case, the vehicle network may include a controller area network (CAN), a local interconnect network (LIN), a flexRay, a media oriented systems transport (MOST), an ethernet, and the like.

The controller 15 performs the overall control to allow each component to perform its function. The controller 15 may be implemented in hardware or software, and of course, may be implemented in the form of a combination of hardware and software. Preferably, the controller 15 may be implemented with a microprocessor, but the embodiment is not limited thereto.

In particular, the controller 15 may distinguish the first impact caused by a fender-bender from the second impact caused by a unpaved road, a speed bump, a pothole, and the like in conjunction with the AVN system 200 mounted on the vehicle and may perform various controls required in the process of preventing the recording of the image corresponding to the second impact.

The controller 15 may determine whether the impact amount received from the impact sensor 13 exceeds the reference value, and when the impact amount exceeds the reference value, the controller 15 may transmit the impact information (information informing that the impact occurred) to the AVN system 200 through the communicator 14. The reason why the impact information is transmitted to the AVN system 200 is that the location of the pothole is not displayed on the electronic map provided by the AVN system 200 when the impact is caused by the pothole.

When receiving the accident exception point information corresponding to the current location from the AVN system 200 after the impact information is transmitted to the AVN system 200, the controller 15 does not store the driving image corresponding to the impact in the storage 11.

After transmitting the impact information to the AVN system 200, when the accident exception point information corresponding to the current location is not received from the AVN system 200, based on the time point at which the impact amount is received, the controller 15 stores the driving image for the threshold time immediately before and the threshold time immediately after the time point in the storage 11.

Meanwhile, the AVN system 200, which is a module mounted in a vehicle, may include the communicator 21, a controller 22, and storage 23.

The communicator 21 is a module that provides a connection interface with the communicator 14 provided in the apparatus 100 for recording a driving image, and when receiving the impact information from the apparatus 100 for recording a driving image, may transmit the accident exception point information corresponds to the current location of the vehicle to the apparatus 100 for recording a driving image.

The communicator 21 may be replaced with a network connection device (not shown) that can connect to a vehicle network. In this case, the vehicle network may include a controller area network (CAN), a local interconnect network (LIN), FlexRay, a media oriented systems transport (MOST), Ethernet, and the like.

When the controller 22 receives the impact information transmitted from the apparatus 100 for recording a driving image, the controller 22 may grasp a current GPS location and match the impact information with the GPS location to store the impact information in the storage 23.

When receiving the impact information at the same location more than the reference number of times, the controller 22 may set the location as an accident exception point.

When the controller 22 receives the impact information from the apparatus 100 for recording a driving image, the controller 22 may transmit the accident exception point information corresponding to the current location to the apparatus 100 for recording a driving image. That is, when the current location of the vehicle corresponds to the accident exception point, the controller 22 may transmit information (accident exception point information) informing the accident exception point to the apparatus 100 for recording a driving image.

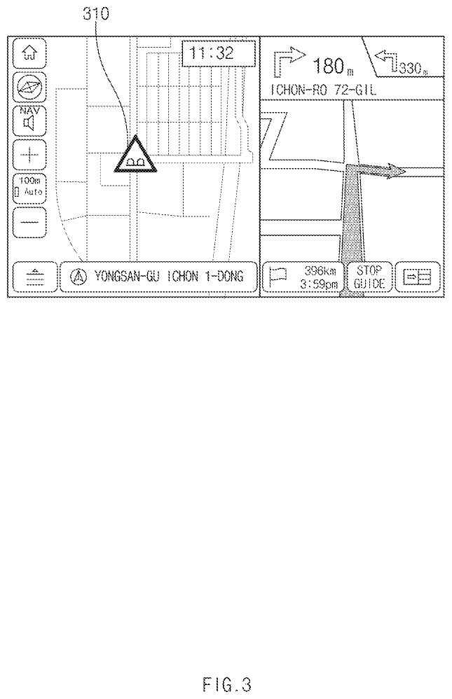

The controller 22 may display an accident exception point 310 on the navigation map as shown in FIG. 3.

FIG. 3 is a view illustrating an accident exception point displayed on a navigation map by a controller provided in an AVN system according to an embodiment of the present disclosure.

As illustrated in FIG. 3, the AVN system 200 may display a route to a destination together with a surrounding map based on the current location of a vehicle.

In addition, the controller 22 provided in the AVN system may additionally display the accident exception point 310 on the navigation map, so that the driver may predict the occurrence of impact in advance, thereby preparing for the impact.

Meanwhile, the controller 22 may provide the location information of the accident exception position information through the communicator 21 to an external navigation map management server (not shown) to be available in all AVN systems under the management of the navigation map management server.

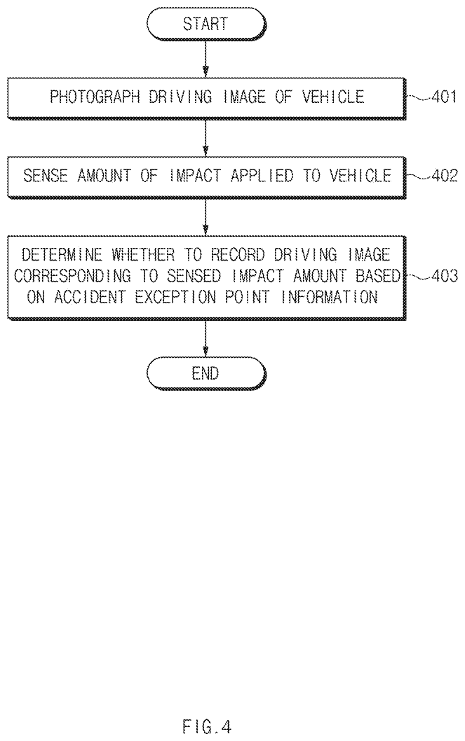

FIG. 4 is a flowchart illustrating a method of recording a driving image of a vehicle according to an embodiment of the present disclosure.

First, in operation 401, the photographing device 12 photographs the driving image of the vehicle.

Thereafter, in operation 402, the impact sensor 13 senses the amount of impact applied to the vehicle.

Thereafter, in operation 403, the controller 15 determines whether to record the driving image corresponding to the amount of impact sensed by the impact sensor 13 based on the accident exception point information. In this case, the controller 15 transmits the impact information to the AVN system 200 when the sensed impact amount exceeds the reference value, and the AVN system 200 grasps the current location and matches and stores the impact information with the location information. When the impact information is received more than the reference number of times at the same location, the location is set as an accident exception point. In addition, as the AVN system 200 receives the impact information from the controller 15, when the current location is included in the accident exception point information, the AVN system 200 transmits the accident exception point to the controller 15.

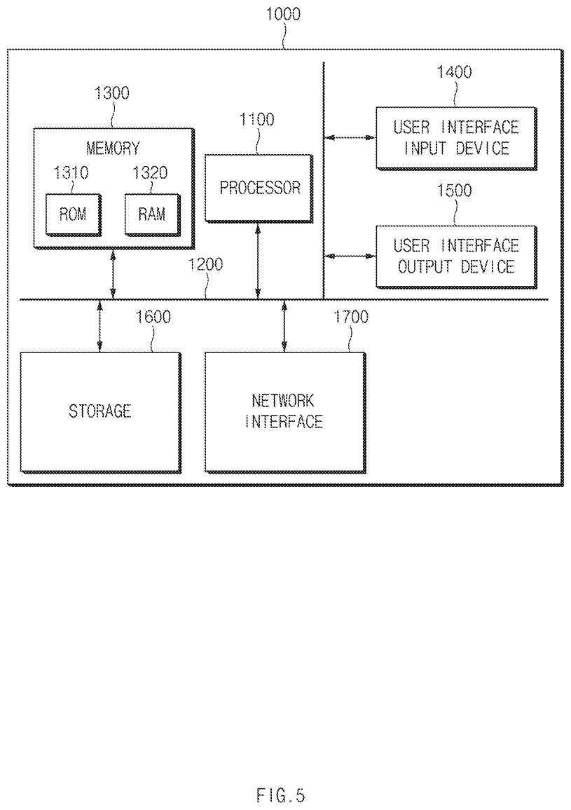

FIG. 5 is a block diagram illustrating a computing system that executes a method of recording a driving image of a vehicle according to an embodiment of the present disclosure.

Referring to FIG. 5, a method of recording a driving image of a vehicle according to an embodiment of the present disclosure may be implemented through a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EFPROM, a register, a hard disk, a removable disk, a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the embodiments of the present disclosure, the apparatus and method for recording a driving image of a vehicle may distinguish the first impact caused by a fender bender from the second impact caused by a unpaved road, a pothole, a speed bump, and the like in conjunction with an AVN system mounted on a vehicle and prevent the image corresponding to the second impact from being recorded, so that it is possible to save resources required for the recording of unnecessary images and to prevent the storage space shortage due to the recording of the unnecessary images in advance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. An apparatus for recording a driving image of a vehicle, the apparatus comprising:
a photographing device configured to photograph the driving image of the vehicle;
an impact sensor configured to sense an impact amount applied to the vehicle; and
a controller configured to determine whether to record a driving image corresponding to the impact amount sensed by the impact sensor based on accident exception point information.

2. The apparatus of claim 1, wherein the controller is configured to record the driving image corresponding to the impact amount when receiving accident exception point information corresponding to a current location from an audio video navigation (AVN) system mounted on the vehicle, and configured to not record the driving image corresponding to the impact amount when not receiving the accident exception point information.

3. The apparatus of claim 1, wherein the controller is configured to transmit impact information to an audio video navigation (AVN) system when the impact amount sensed by the impact sensor exceeds a reference value.

4. The apparatus of claim 3, wherein the AVN system is configured to grasp a current location when receiving the impact information and match the impact information with location information to store the impact information.

5. The apparatus of claim 4, wherein the AVN system is configured to set the current location as an accident exception point when receiving the impact information a reference number of times or more at a same location.

6. The apparatus of claim 5, wherein the AVN system is configured to display the accident exception point on a navigation map.

7. The apparatus of claim 1, wherein the photographing device is configured to photograph a driving image of at least one of front, rear, left and right sides of the vehicle.

8. A method of recording a driving image of a vehicle, the method comprising:
photographing, by a photographing device, the driving image of the vehicle;
sensing, by an impact sensor, an impact amount applied to the vehicle; and
determining, by a controller, whether to record a driving image corresponding to the sensed impact amount based on accident exception point information.

9. The method of claim 8, wherein the determining of whether to recording the driving image includes:
recording the driving image corresponding to the impact amount when receiving accident exception point information corresponding to a current location from an audio video navigation (AVN) system mounted on the vehicle; and
not recording the driving image corresponding to the impact amount when not receiving the accident exception point information.

10. The method of claim 9, wherein the determining of whether to recording the driving image includes:
transmitting impact information to the AVN system when the sensed impact amount exceeds a reference value;
grasping, by the AVN system, a current location;
matching, by the AVN system, the impact information with location information to store the impact information; and
setting, by the AVN system, the current location as an accident exception point when the impact information is received a reference number of times or more at a same location.

11. The method of claim 10, further comprising:
displaying, by the AVN system, the accident exception point on a navigation map.

12. The method of claim 8, wherein the photographing of the driving image of the vehicle includes:
photographing a driving image of at least one of front, rear, left and right sides of the vehicle.
